(19) United States
(12) Patent Application Publication
(10) Pub. No.: US 2015/0173307 A1
(43) Pub. Date: Jun. 25, 2015

(54) ADAPTIVE GREENHOUSE CONTROL METHOD

(71) Applicant: Electronics and Telecommunications Research Institute, Daejeon (KR)

(72) Inventors: Dong Wan RYOO, Daejeon (KR); Hae Dong LEE, Daegu (KR); Ae Kyeung MOON, Daegu (KR); Jang Sik BAE, Daegu (KR); Sang Ho Lee, Daegu (KR); Song Li, Daegu (KR); Jin Hong Kim, Daegu (KR); Soo In Lee, Daejeon (KR)

(73) Assignee: Electronics and Telecommunications Research Institute, Daejeon (KR)

(21) Appl. No.: 14/188,870

(22) Filed: Feb. 25, 2014

(30) Foreign Application Priority Data
Dec. 20, 2013 (KR) 10-2013-0159946

(51) Int. Cl. A01G 9/14

(52) U.S. Cl. CPC A01G 9/14

(57) ABSTRACT

Provided is an adaptive greenhouse control method that can control a greenhouse to provide an optimized environment by automatically and daily adapting to an external environment and a type of the greenhouse. The method includes performing a P-Band setting operation of setting a P-Band to determine a degree of which a greenhouse window is opened according to a current greenhouse inside temperature based on a predetermined set temperature, performing a greenhouse control operation of controlling the degree of which a greenhouse window is opened according to the P-Band, performing a greenhouse environment parameter measurement operation of measuring a greenhouse environment parameter value applied to set the P-Band, performing a P-Band changing operation of changing the P-Band according to the greenhouse environment parameter value, and performing a greenhouse change control operation of controlling the degree of which a greenhouse window is opened according to the P-Band changed in the P-Band changing operation.

### CROSS-REFERENCE TO RELATED APPLICATIONS

This application claims priority under 35 U.S.C. §119 to Korean Patent Application No. 10-2013-0159946, filed on Dec. 20, 2013, the disclosure of which is incorporated herein by reference in its entirety.

### TECHNICAL FIELD

The present invention relates to an adaptive greenhouse control method, and more particularly, to an adaptive greenhouse control method that can control a greenhouse to provide an optimized environment by automatically and daily adapting to an external environment and a type of the greenhouse.

### BACKGROUND

Generally, qualities, such as a growth rate, a yield, a flavor, etc., of crops cultivated in greenhouses are affected by temperature, humidity, sunshine, water supply, carbon dioxide, etc. Accordingly, instruments are used to maintain temperature, humidity, and sunshine at constant levels in greenhouses. However, there is a limitation in that farmers or managers should directly activate instruments in greenhouses.

Thus, farmers or managers activate instruments for maintaining temperature, humidity, and sunshine at constant levels while considering necessary conditions using specialized knowledge.

In this case, there is a limitation in that the farmers or managers should control, monitor, and manage instruments for maintaining temperature, humidity, and sunshine at constant levels in order to increase a crop yield.

In the related art, greenhouses are automatically managed in order to overcome the limitation. However, greenhouses are implemented in various forms such as a glass greenhouse type, a vinyl greenhouse sunlight type, a hybrid type, and an artificial light plant factory type, and configured to include various sensors for monitoring greenhouse environments and various actuators corresponding to the various sensors.

However, the control of a greenhouse is greatly affected by an external environment (external temperature, wind direction, wind speed, etc.) and a type (greenhouse size, greenhouse window size, etc.) of the greenhouse.

Since the external environment and the type of the greenhouse greatly differ between greenhouse installation regions, it is considerably difficult to configure the external environment and the type of the greenhouse with the same control model. Generally, the greenhouse control is directly performed based on experiences of the farmers or managers.

In this case, irrespective of crop growth conditions in greenhouses, for example, temperature, humidity, sunshine, etc. for optimizing the crop growth, the crop growth is automatically managed on the basis of experiences of the farmers or managers. Thus, it is impossible to efficiently control the crop growth environment, which may affect the crop yield.

Accordingly, more effective greenhouse control technology is necessary according to a greenhouse installation region and a greenhouse type.

### SUMMARY

Accordingly, the present invention provides an adaptive greenhouse control method that can control a greenhouse to provide an optimized environment by automatically and daily adapting to an external environment and a type of a greenhouse.

In one general aspect, an adaptive greenhouse control method includes: performing a P-Band setting operation of setting a P-Band to determine a degree of which a greenhouse window is opened according to a current greenhouse inside temperature based on a predetermined set temperature; performing a greenhouse control operation of controlling the degree of which a greenhouse window is opened according to the P-Band; performing a greenhouse environment parameter measurement operation of measuring a greenhouse environment parameter value applied to set the P-Band; performing a P-Band changing operation of changing the P-Band according to the greenhouse environment parameter value; and performing a greenhouse change control operation of controlling the degree of which a greenhouse window is opened according to the P-Band changed in the P-Band changing operation.

The greenhouse environment parameter may include at least one of an outside temperature, a wind direction, a wind speed, a greenhouse size, and a greenhouse window size.

The P-Band may be defined as a linear equation having a slope and an intercept.

In the P-Band changing operation, change of the P-Band may include changing the slope.

In the P-Band changing operation, change of the P-Band may include changing the intercept.

The change of the slope of the P-Band may include: performing a one-day performance index calculation operation of calculating a one-day performance index according to a slope value of a current-day P-Band, using a difference between the greenhouse inside temperature and the set temperature; performing a performance index variation calculation operation of calculating one-day performance index variation based on the slope value of the current-day P-Band and a slope value of a previous-day P-Band; performing a slope changing operation of changing the slope value of the current-day P-band in an opposite direction of the performance index variation to calculate a slope value of a next-day P-Band; and performing an error determination operation of determining whether the performance index is within a tolerance range.

In the one-day performance index calculation operation, the one-day performance index J may be calculated using a following equation:

$$J = \frac{1}{m} {\sum }_{k = 0}^{m} {( Error ( k ) )}^{2}$$

where Error=Y−Y_{d}, Y is the greenhouse inside temperature, and Y_{d} is the set temperature.

In the performance index variation calculation operation, the one-day performance index variation ∇J may be calculated using a following equation:

$$∇ J = \frac{\partial J ( A )}{\partial A} \approx {lim}_{w -> 0} ( \frac{J ( {A}_{y} + W ) - J \cdot {A}_{y}}{w} )$$

where w is a constant, (A_{y}+W) is the slope value of the current-day P-band, A_{y} is the slope value of the previous-day P-band, J(A_{y}+W) is a performance index using the slope value of the current-day P-band, and J(A_{y}) is a performance index using the slope value of the previous-day P-band.

In the slope changing operation, the slope value A(data+1) of the next-day P-Band may be calculated using a following equation:

$$A ( data + 1 ) = A ( data ) - μ \frac{\partial J ( A )}{\partial A}$$

where μ is a constant and A(data) is the slope value of the current-day P-band.

The change of the intercept of the P-Band may include: performing a one-day performance index calculation operation of calculating a one-day performance index according to an intercept value of a current-day P-Band, using a difference between the greenhouse inside temperature and the set temperature; performing a performance index variation calculation operation of calculating one-day performance index variation based on the intercept value of the current-day P-Band and an intercept value of a previous-day P-Band; performing an intercept changing operation of changing the intercept value of the current-day P-band in an opposite direction of the performance index variation to calculate an intercept value of a next-day P-Band; and performing an error determination operation of determining whether the performance index is within a tolerance range.

In the one-day performance index calculation operation, the one-day performance index J is calculated using a following equation:

$$J = \frac{1}{m} {\sum }_{k = 0}^{m} {( Error ( k ) )}^{2}$$

where Error=Y−Y_{d}, Y is the greenhouse inside temperature, and Y_{d} is the set temperature.

In the performance index variation calculation operation, the one-day performance index variation ∇J may be calculated using a following equation:

$$∇ J = \frac{\partial J ( b )}{\partial b} \approx {lim}_{w -> 0} ( \frac{J ( {b}_{y} + W ) - J \cdot {b}_{y}}{w} )$$

where w is a constant, (b_{y}+W) is the intercept value of the current-day P-band, b_{y} is the intercept value of the previous-day P-band, J(b_{y}+W) is a performance index according to the intercept value of the current-day P-band, and J(b_{y}) is a performance index according to the intercept value of the previous-day P-band.

In the intercept changing operation, the intercept value b(data+1) of the next-day P-Band is calculated using a following equation:

$$b ( data + 1 ) = b ( data ) - μ \frac{\partial j ( b )}{\partial b}$$

where b(data) is an intercept value of the current-day P-band.

Other features and aspects will be apparent from the following detailed description, the drawings, and the claims.

### BRIEF DESCRIPTION OF THE DRAWINGS

FIG. 1 is a flowchart illustrating an adaptive greenhouse control method according an embodiment of the present invention.

FIG. 2 is a block diagram showing a greenhouse control system applying an adaptive greenhouse control method according to an embodiment of the present invention.

FIG. 3 is a graph showing an example in which a slope of a P-Band function is changed according to an embodiment of the present invention.

FIG. 4 is a graph showing an example in which an intercept of a P-Band function is changed according to an embodiment of the present invention.

FIG. 5 is a flowchart illustrating changing a slope of a P-Band in an adaptive greenhouse control method according an embodiment of the present invention.

FIG. 6 is a flowchart illustrating changing an intercept of a P-Band in an adaptive greenhouse control method according an embodiment of the present invention.

### DETAILED DESCRIPTION OF EMBODIMENTS

Hereinafter, preferred embodiments of the present invention will be described in detail with reference to the accompanying drawings such that a person skilled in the art may easily carry out the embodiments of the present invention. In the specification, the thickness of lines or the size of elements shown in the drawings may be enlarged for the clarity of a description and for the sake of convenience. Also, the terms described below are defined with consideration of the functions in the present invention, and thus may vary depending on a user, intention of an operator, or custom. Therefore, the terms should be defined based on the description rather than the specification.

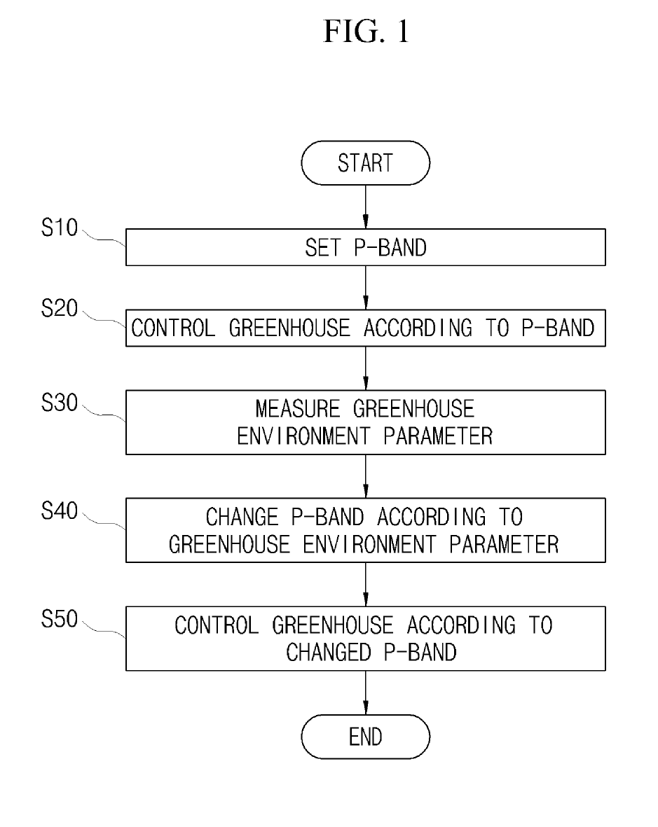

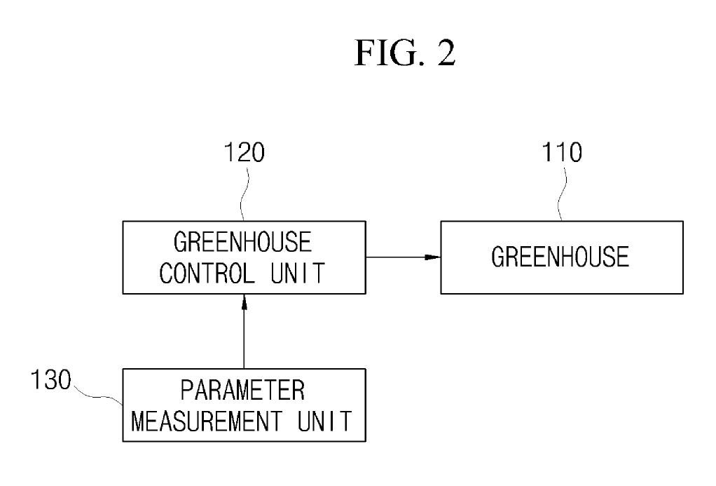

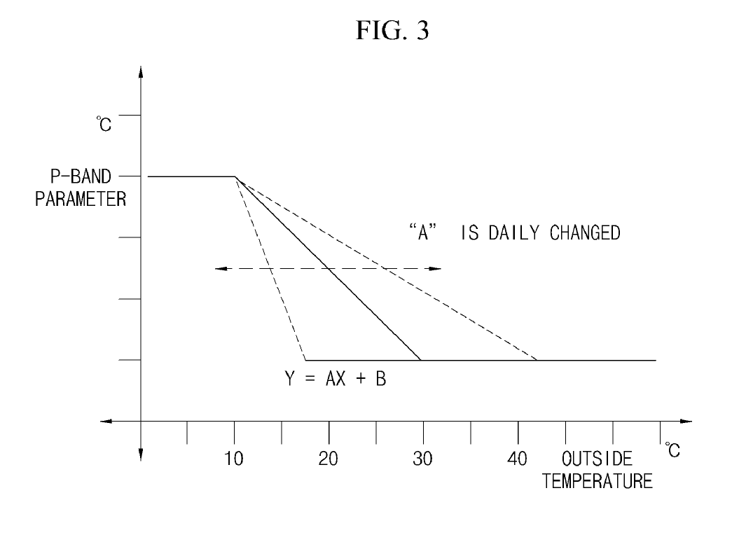

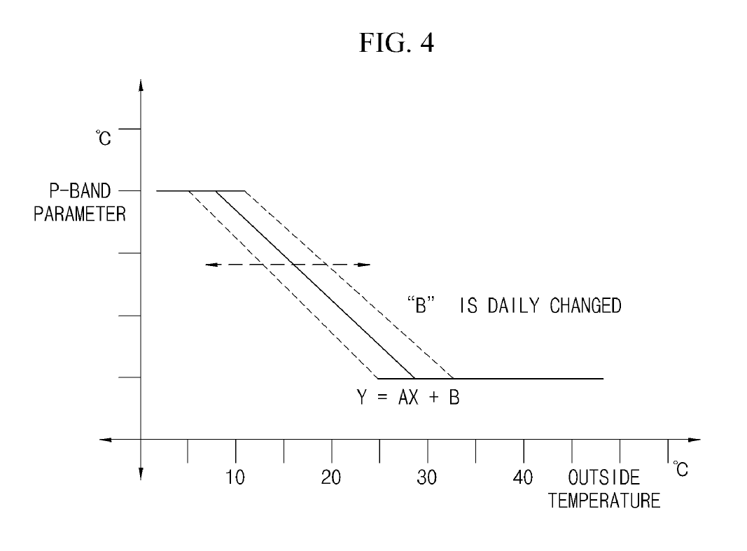

FIG. 1 is a flowchart illustrating an adaptive greenhouse control method according an embodiment of the present invention, FIG. 2 is a block diagram showing a greenhouse control system applying an adaptive greenhouse control method according to an embodiment of the present invention, FIG. 3 is a graph showing an example in which a slope of a P-Band function is changed according to an embodiment of the present invention, and FIG. 4 is a graph showing an example in which an intercept of a P-Band function is changed according to an embodiment of the present invention.

Referring to FIG. 1, an adaptive greenhouse control method according to an embodiment of the present invention includes a P-Band setting operation S10, a greenhouse control operation S20, a greenhouse environment parameter measurement operation S30, a P-Band changing operation S40, and a greenhouse change control operation S50.

Referring to FIG. 2, a greenhouse control system 100 applying the adaptive greenhouse control method of the present invention may include a greenhouse control unit 120 configured to control a greenhouse 110 according th the adaptive greenhouse control method and a parameter measurement unit 130 configured to measure a greenhouse environment parameter that is provided to the greenhouse control unit 120.

The adaptive greenhouse control method according to the present invention will be described in detail below with reference to FIGS. 1 and 2.

The P-Band setting operation S10 is an operation of setting a P-Band used to determine the degree of which a greenhouse window is opened according to a greenhouse inside temperature with respect to a predetermined set temperature, which may be performed by the greenhouse control unit 120.

In this case, the P-Band is a range that represents an excess over the set temperature in degrees Celsius when a greenhouse window is opened to 100%.

That is, the P-Band represents, as a percentage, the degree to which the greenhouse window is opened when the internal temperature increases by 1 degree from the set temperature.

In this case, the set temperature is set based on a greenhouse environment, for example, specifically a greenhouse external environment or greenhouse type, in which the greenhouse external environment may be a temperature, a wind direction, a wind speed, etc. and the greenhouse type may include a greenhouse size, greenhouse window size, etc.

However, the greenhouse environment that is applied to set the set temperature may include another parameter in addition to the external temperature, the wind direction, the wind speed, the greenhouse size, and the greenhouse window size.

In addition, when the set temperature is set, all of the above-described parameters may be applied or some of the above-described parameters may be applied. However, if a number of parameters are applied when the set temperature is set, the greenhouse control may be achieved more accurately and finely.

Accordingly, since the P-Band represents the degree to which the greenhouse window is opened when the greenhouse inside temperature increases by 1 degree from the set temperature that is set on the basis of the greenhouse environment, it is possible to adaptively control the greenhouse according to the greenhouse environment when the degree to which the greenhouse window is opened is determined according to the P-Band.

For example, in a case in which a target greenhouse inside temperature is 20° C., the P-Band may be set such that a greenhouse window may be opened to 100% when an actual greenhouse inside temperature is 25° C. and a greenhouse window is allowed to be opened to 60% when an actual greenhouse inside temperature is 23° C.

Accordingly, the P-Band is set such that the degree to which the greenhouse window is opened according to the difference between the set temperature and the actual greenhouse inside temperature may be linear.

The greenhouse control operation S20 is an operation of controlling a greenhouse according to a P-Band that is set in the P-Band setting operation S10, which may be performed by the greenhouse control unit 120.

In this case, since the P-Band is used to determine the degree to which the greenhouse window is opened according to the difference between the set temperature and the actual greenhouse inside temperature, the greenhouse is controlled by controlling the degree to which the greenhouse window in the greenhouse control operation S20.

That is, as described above, in a case in which the temperature control is performed according to the P-Band that is set such that the greenhouse window may be opened to 100% when a set temperature is 20° C. and an actual greenhouse inside temperature is 25° C., if the greenhouse inside temperature is 23° C., the greenhouse window may be controlled to be opened to 60%.

The greenhouse environment parameter measurement operation S30 is an operation of measuring a greenhouse environment parameter applied to set the P-Band, which may be performed by the parameter measurement unit 130.

The parameter measurement unit 130 transmits the measured greenhouse environment parameter to the greenhouse control unit 120.

In the embodiment, for example, the outside temperature, the wind direction, the wind speed, the greenhouse size, and the greenhouse window size may be applied in order to set the P-Band function. Accordingly, in the greenhouse environment parameter measurement operation S30, the outside temperature, the wind direction, the wind speed, the greenhouse size, and the greenhouse window size may be measured.

The P-Band changing operation S40 is an operation of changing the P-Band function according to the parameter measured in the greenhouse environment parameter measurement operation S30, which may be performed by the greenhouse control unit 120 according to the greenhouse environment parameter transmitted from the parameter measurement unit 130.

Accordingly, since the P-Band function changed according to the P-Band changing operation S40 is set according to an optimal condition for controlling the greenhouse according to the current greenhouse environment, the optimal condition may be automatically provided when the greenhouse is controlled. In this case, the P-Band changing operation S40 may be performed daily.

For example, the greenhouse window is set to be opened to 100% when the set temperature is 20° C. and the actual greenhouse inside temperature is 25° C. in the P-Band setting operation S10. However, in the P-Band changing operation S40, the greenhouse window may be set as a function with a slope that is set to be opened to 100% when the set temperature is 22° C. and the actual greenhouse inside temperature is 32° C.

In this case, when the P-Band having a linear function is changed according to the P-Band changing operation S40, the slope of the P-Band may be changed as shown in FIG. 3, and the intercept of the P-Band may be changed as shown in FIG. 4.

The greenhouse change control operation S50 is an operation of automatically controlling the greenhouse by opening the greenhouse window according to the P-Band changed in the P-Band changing operation S40, which may be performed by the green control unit 120.

According to the adaptive greenhouse control method of the present invention, the greenhouse may be controlled to provide an environment that is automatically adapted and optimized, by setting a P-Band to determine the degree of which the greenhouse window is opened according to the greenhouse environment and allowing the greenhouse window to be automatically opened according to the set P-Band.

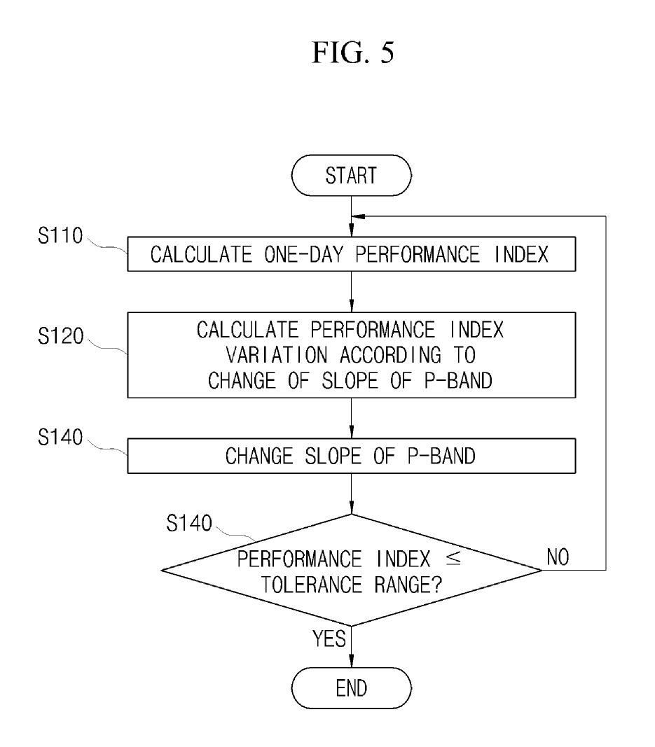

FIG. 5 is a flowchart illustrating changing a slope of a P-Band in an adaptive greenhouse control method according an embodiment of the present invention.

Referring to FIG. 5, the change of the slope of the P-Band includes a one-day performance index calculation operation S110, a performance index variation calculation operation S120, a slope changing operation S130, and an error determination operation S140.

The one-day performance index calculation operation S110 calculates a one-day performance index according to a slope value of a current-day P-Band, using the difference between the greenhouse inside temperature and the set temperature.

In this case, the one-day performance index J may be determined using Equation (1) below:

$$J = \frac{1}{m} {\sum }_{k = 0}^{m} {( Error ( k ) )}^{2} \qquad ( 1 )$$

where Error=Y−Y_{d}, Y is the greenhouse inside temperature, and Y_{d} is the set temperature.

The performance index variation calculation operation S120 calculates one-day performance index variation according to the slope value of the current-day P-Band and a slope value of a previous-day P-Band, and the one-day performance index variation ∇J is calculated using Equation (2) below:

$$∇ J = \frac{\partial J ( A )}{\partial A} \approx {lim}_{w -> 0} ( \frac{J ( {A}_{y} + W ) - J \cdot {A}_{y}}{w} ) \qquad ( 2 )$$

where w is a constant, (A_{y}+W) is the slope value of the current-day P-Band, A_{y} is the slope value of the previous-day P-Band, J(A_{y}+W) is a performance index according to the slope value of the current-day P-Band, and J(A_{y}) is a performance index according to the slope value of the previous-day P-Band.

The slope changing operation S130 changes the slope value of the current-day P-Band in an opposite direction of the performance index variation to calculate a slope value A(data+1) of a next-day P-Band.

In this case, the slope value A(data+1) of the next-day P-Band may be calculated using Equation (3) below:

$$A ( data + 1 ) = A ( data ) - μ \frac{\partial J ( A )}{\partial A} \qquad ( 3 )$$

where μ is a constant and A(data) is the slope value of the current-day P-Band.

The error determination operation S140 determines whether the performance index is within a tolerance range, the change of the slope of the P-Band is ended if the performance index is within the tolerance range, and the one-day performance index calculation operation S110 is performed if the performance index is out of the tolerance range.

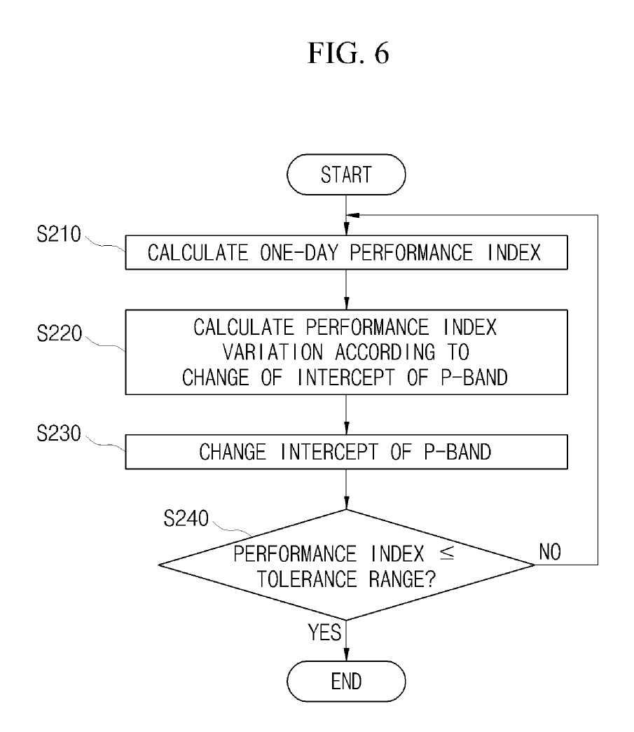

FIG. 6 is a flowchart illustrating changing an intercept of a P-Band in an adaptive greenhouse control method according an embodiment of the present invention.

Referring to FIG. 6, the change of the intercept of the P-Band includes a one-day performance index calculation operation S210, a performance index variation calculation operation S220, an intercept changing operation S230, and an error determination operation S240.

The one-day performance index calculation operation S210 calculates a one-day performance index J according to an intercept value of a current-day P-Band, using the difference between the greenhouse inside temperature and the set temperature.

In this case, the one-day performance index J may be determined using Equation (4) below:

$$J = \frac{1}{m} {\sum }_{k = 0}^{m} {( Error ( k ) )}^{2} \qquad ( 4 )$$

where Error=Y−Y_{d}, Y is the greenhouse inside temperature, and Y_{d} is the set temperature.

The performance index variation calculation operation S220 calculates one-day performance index variation according to the intercept value of the current-day P-Band and an intercept value of a previous-day P-Band, and the one-day performance index variation ∇J is calculated using Equation (5) below:

$$∇ J = \frac{\partial J ( b )}{\partial b} \approx {lim}_{w -> 0} ( \frac{J ( {b}_{y} + W ) - J \cdot {b}_{y}}{w} ) \qquad ( 5 )$$

where w is a constant, (b_{y}+W) is the intercept value of the current-day P-Band, b_{y} is the intercept value of the previous-day P-Band, J(b_{y}+W) is a performance index according to the intercept value of the current-day P-Band, and J(b_{y}) is a performance index according to the intercept value of the previous-day P-Band.

The intercept changing operation S230 changes the intercept value of the current-day P-Band in an opposite direction of the performance index variation to calculate an intercept value b(data+1) of a next-day P-Band.

In this case, the intercept value b(data+1) of the next-day P-Band may be calculated using Equation (6) below:

$$b ( data + 1 ) = b ( data ) - μ \frac{\partial j ( b )}{\partial b} \qquad ( 6 )$$

where b(data) is the intercept value of the current-day P-Band.

The error determination operation S240 determines whether the performance index is within a tolerance range, the change of the intercept of the P-Band is ended if the performance index is within the tolerance range, and the one-day performance index calculation operation S210 is performed if the performance index is out of the tolerance range.

According to the adaptive greenhouse control method of the present invention, it is possible to provide an optimized greenhouse environment by setting a P-Band to determine the degree of which the greenhouse window is opened according to the greenhouse environment and automatically controlling the greenhouse window according to the set P-Band.

As described above, the adaptive greenhouse control method according to the present invention has been described according to preferred embodiments. However, the present invention is not limited to the particularly preferred embodiments. It is apparent to one skilled in the art that there are many various modifications and variations without departing off from the spirit or the technical scope of the appended claims.

Accordingly, the embodiments of the present invention are to be considered descriptive and not restrictive of the present invention, and do not limit the scope of the present invention. The scope of the present invention should be determined by the following claims and their appropriate legal equivalents.

What is claimed is:

1. An adaptive greenhouse control method comprising:
performing a P-Band setting operation of setting a P-Band to determine a degree of which a greenhouse window is opened according to a current greenhouse inside temperature based on a predetermined set temperature;
performing a greenhouse control operation of controlling the degree of which a greenhouse window is opened according to the P-Band;
performing a greenhouse environment parameter measurement operation of measuring a greenhouse environment parameter value applied to set the P-Band;
performing a P-Band changing operation of changing the P-Band according to the greenhouse environment parameter value; and
performing a greenhouse change control operation of controlling the degree of which a greenhouse window is opened according to the P-Band changed in the P-Band changing operation.

2. The adaptive greenhouse control method of claim 1, wherein the greenhouse environment parameter comprises at least one of an outside temperature, a wind direction, a wind speed, a greenhouse size, and a greenhouse window size.

3. The adaptive greenhouse control method of claim 1, wherein the P-Band is defined as a linear equation having a slope and an intercept.

4. The adaptive greenhouse control method of claim 3, wherein in the P-Band changing operation, change of the P-Band comprises changing the slope.

5. The adaptive greenhouse control method of claim 3, wherein in the P-Band changing operation, change of the P-Band comprises changing the intercept.

6. The adaptive greenhouse control method of claim 4, wherein the change of the slope of the P-Band comprises:
performing a one-day performance index calculation operation of calculating a one-day performance index according to a slope value of a current-day P-Band, using a difference between the greenhouse inside temperature and the set temperature;
performing a performance index variation calculation operation of calculating one-day performance index variation based on the slope value of the current-day P-Band and a slope value of a previous-day P-Band;
performing a slope changing operation of changing the slope value of the current-day P-band in an opposite direction of the performance index variation to calculate a slope value of a next-day P-Band; and
performing an error determination operation of determining whether the performance index is within a tolerance range.

7. The adaptive greenhouse control method of claim 6, wherein in the one-day performance index calculation operation, the one-day performance index J is calculated using a following equation:
$$J = \frac{1}{m} {\sum }_{k = 0}^{m} {( Error ( k ) )}^{2}$$
where Error=Y−Y_{d}, Y is the greenhouse inside temperature, and Y_{d} is the set temperature.

8. The adaptive greenhouse control method of claim 6, wherein in the performance index variation calculation operation, the one-day performance index variation 7J is calculated using a following equation:
$$∇ J = \frac{\partial J ( A )}{\partial A} \approx {lim}_{w -> 0} ( \frac{J ( {A}_{y} + W ) - J \cdot {A}_{y}}{w} )$$
where w is a constant, (A_{y}+W) is the slope value of the current-day P-band, A_{y} is the slope value of the previous-day P-band, J(A_{y}+W) is a performance index using the slope value of the current-day P-band, and J(A_{y}) is a performance index using the slope value of the previous-day P-band.

9. The adaptive greenhouse control method of claim 6, wherein in the slope changing operation, the slope value A(data+1) of the next-day P-Band is calculated using a following equation:
$$A ( data + 1 ) = A ( data ) - μ \frac{\partial J ( A )}{\partial A}$$
where μ is a constant and A(data) is the slope value of the current-day P-band.

10. The adaptive greenhouse control method of claim 5, wherein the change of the intercept of the P-Band comprises:
performing a one-day performance index calculation operation of calculating a one-day performance index according to an intercept value of a current-day P-Band, using a difference between the greenhouse inside temperature and the set temperature;
performing a performance index variation calculation operation of calculating one-day performance index variation based on the intercept value of the current-day P-Band and an intercept value of a previous-day P-Band;
performing an intercept changing operation of changing the intercept value of the current-day P-band in an opposite direction of the performance index variation to calculate an intercept value of a next-day P-Band; and
performing an error determination operation of determining whether the performance index is within a tolerance range.

11. The adaptive greenhouse control method of claim 10, wherein in the one-day performance index calculation operation, the one-day performance index J is calculated using a following equation:
$$J = \frac{1}{m} {\sum }_{k = 0}^{m} {( Error ( k ) )}^{2}$$
where Error=Y−Y_{d}, Y is the greenhouse inside temperature, and Y_{d} is the set temperature.

12. The adaptive greenhouse control method of claim 10, wherein in the performance index variation calculation operation, the one-day performance index variation 7J is calculated using a following equation:
$$∇ J = \frac{\partial J ( b )}{\partial b} \approx {lim}_{w -> 0} ( \frac{J ( {b}_{y} + W ) - J \cdot {b}_{y}}{w} )$$
where w is a constant, (b_{y}+W) is the intercept value of the current-day P-band, b_{y} is the intercept value of the previous-day P-band, J(b_{y}+W) is a performance index according to the intercept value of the current-day P-band, and J(b_{y}) is a performance index according to the intercept value of the previous-day P-band.

13. The adaptive greenhouse control method of claim 10, wherein in the intercept changing operation, the intercept value b(data+1) of the next-day P-Band is calculated using a following equation:
$$b ( data + 1 ) = b ( data ) - μ \frac{\partial j ( b )}{\partial b}$$
where b(data) is an intercept value of the current-day P-band.
